(19) United States
(12) Patent Application Publication
(10) Pub. No.: US 2009/0282432 A1
(43) Pub. Date: Nov. 12, 2009

(54) Apparatus and Method for Securely Distributing Contents in a Telecommunication Network

(76) Inventors: Dirk Hahnefeld, Gauting (DE); Norbert Loebig, Darmstadt (DE)

Correspondence Address: MICHAEL N. HAYNES, 1341 HUNTERSFIELD CLOSE, KESWICK, VA, 22947, US

(21) Appl. No.: 12/440,641

(22) PCT Filed: Sep. 7, 2007
(86) PCT No.: PCT/EP07/59402

§ 371 Date: Mar. 10, 2009

(30) Foreign Application Priority Data
Sep. 20, 2006 (DE) DE102006044299.7

(51) Int. Cl. H04N 7/167; G06Q 30/00; G06F 21/24; H04L 29/06

(52) U.S. Cl. 725/31; 705/26; 705/59; 713/162

(57) ABSTRACT

The invention relates to an apparatus and a method for securely distributing contents in a telecommunication network, where an inventory management unit (1) manages terminals (3) with at least one functional unit (4) on the basis of use rights metadata (NMD) associated with an encrypted content (VN) and a terminal actuation unit (2) actuates the terminals (3) as appropriate. In this case, the inventory management unit (1) compares the use rights metadata (NMD) with a functional unit inventory list, the terminal actuation unit (2) selectively actuating the respective terminal for a respective encrypted content if the comparison ascertains a functional unit (4) which is not enabled for the content.

### BRIEF DESCRIPTION OF THE DRAWINGS

In the text which follows, the invention will be described in greater detail with reference to exemplary embodiments, referring to the drawing, in which:

FIG. 1 shows a simplified block diagram for illustrating an apparatus for securely distributing contents in a telecommunication network;

FIG. 2 shows a simplified block diagram for illustrating a VoD solution according to a first exemplary embodiment;

FIG. 3 shows a simplified block diagram for illustrating a VoD solution according to a second exemplary embodiment;

FIG. 4 shows a simplified block diagram for illustrating a VoD solution according to a third exemplary embodiment;

FIG. 5 shows a simplified block diagram for illustrating a VoD solution according to a fourth exemplary embodiment;

FIG. 6 shows a simplified block diagram for illustrating a TV head end solution according to a first exemplary embodiment;

FIG. 7 shows a simplified block diagram for illustrating a TV head end solution according to a second exemplary embodiment; and

FIG. 8 shows a simplified flowchart for illustrating essential method steps of the method according to the invention.

### DESCRIPTION

The present invention relates to an apparatus and to a method for securely distributing contents in a telecommunication network and particularly to an apparatus and to a method for individually providing encrypted contents via public communication networks by utilizing digital rights management systems.

As the individual provision of contents such as, for example, video data (films) or audio data (music/sound radio contributions) is made possible via public communication networks, e.g. as video on demand (VoD), there is an increased requirement for protecting such contents against the unauthorized creation of copies. This requirement is met by current system architectures for providing, for example, VoD (Video on Demand) via packet-switching networks such as, for example, IP (Internet Protocol) networks having in each case their own digital rights management method (DRM). This ensures that a respective content e.g. is copy-protected on its way from a video server to a telecommunication terminal such as, for example, a set-top box (STB) and is used as intended by the subscriber.

The use of the content by the subscriber is determined by features of the VoD solution and is generally restricted in this context. In particular, the content is transmitted as encrypted information or as encrypted content, respectively. A centralized coordinating center such as, e.g., a total management middleware (TM) ensures that the subscriber has access to the content, in the manner agreed with the content provider and the subscriber, only in the case of payment. In this context, the content provider trusts the characteristics of the respective VoD solution used by a network operator, warranted with regard to copy protection and prevention of misuse.

Digital rights management (DRM) and copy protection mechanisms, which are being developed with emphasis, particularly with regard to the control of copying and maintenance of permissible use of or by means of optical data media such as, e.g. HD-DVD (High Density Digital Video Disk), Blu-Ray-Disk, are restricted not only to the definition of how a content is to be stored on one of these optical carrier media and how a replay device should read out the content, or how a recording device (e.g. burner) should write the content, but they also simultaneously deal with the case of the propagation of the content via a public communication network such as e.g. an IP network, in the case of which, among other things, a content can also be forwarded by streaming or downloading completely without optical storage media.

In this context, the digital rights management AACS (Advanced Access Content System) already specifies a far-reaching range of functions. However, this is not covered by conventional VoD solutions.

Thus, the content provider (e.g. Disney or Time Warner) currently provides their films in unencrypted form for home entertainment solutions for Video on Demand (VoD), such as, e.g. Siemens HES (Home Entertainment Solution). As an alternative, the content can also be provided encrypted, the key information being additionally provided by the content provider. In both cases, the content on the interface between content provider and the system infrastructure of the network operator, e.g. the content management system (CMS) of the latter, for inserting new contents into the VoD solution, is not secured in accordance with the above-mentioned advanced protection mechanisms of the digital rights management standards. The above digital rights management standards have significance particularly with regard to high-definition contents (HD contents).

In particular, the content provider cannot provide the content on an optical medium defined in accordance with the digital rights management standard for advanced rights and copy protection. In this context, apart from the film encrypted in accordance with the standard, meta information about the intended use of the content, key information, copy protection information, information about permissible replay devices can also be contained which would have to be processed in standard-compliant manner by the content management system and overall VoD system, to be certified as compliant with regard to the standard. Similarly, it is currently not possible to insert the content with equivalent protection, bypassing an optical transmission medium by a direct downloading via a telecommunication network into the content management system or the overall VoD system.

Correspondingly, there are no mechanisms which revoke or exclude in standard-compliant manner replay and recording functions and components of the overall VoD architecture which have been found to be unsecure with regard to a corresponding digital rights management standard, and can thus eliminate a potentially damaging effect or reduced protection characteristics with regard to a digital rights management.

On the basis of the argument of a comparably high protection and a similar protection of contents beyond the system boundaries and preserving its intended use, it must be assumed that the digital rights management and copy protection mechanisms adapted in future by the devices of entertainment electronics will also have to be supported by the VoD solutions. This can be motivated by, e.g., corresponding conditions of the content providers (studios) before delivering the contents to be protected to the operators of the (home entertainment) solution.

The invention is therefore based on the object of creating an apparatus and a method for securely distributing contents in a telecommunication network which has improved protection mechanisms with regard to the preservation of the rights of the respective content providers.

According to the invention, this object is achieved by the features of claim 1 with regard to the apparatus and by the measures of claim 20 with regard to the method.

In this arrangement, an inventory management unit manages terminals with at least one functional unit on the basis of rights-of-use metadata associated with an encrypted content, wherein a terminal actuation unit actuates the terminals as appropriate. In this context, the inventory management unit compares the rights-of-use metadata with a functional-unit inventory list, the terminal actuation unit selectively actuating the terminal for a respective encrypted content if the comparison determines a functional unit which is not enabled for the content. The selective actuation includes, for example, blocking of the terminal and/or of the functional unit or changing a movie or EPG list. This makes it possible to reliably ensure that the terminals present in a telecommunication network are enabled for reproducing an encrypted content only if they exclusively contain unobjectionable functional units and can thus not get around the protection of rights, particularly the copy protection.

Preferably, a clearing house for providing at least a part of decryption metadata for the encrypted content can be provided as a result of which additional securing can also be carried out in dependence on a respective charging.

Furthermore, a rights management unit for providing metadata belonging to the encrypted content, which contain at least a residual part of decryption metadata, and a content provisioning unit for providing the associated encrypted contents can be provided, which ensures optimum adaptation for a telecommunication network. The content provisioning unit in this arrangement can represent a VoD server or a TV head end or TV head station.

Furthermore, a content management unit with an interface adaptation unit for adapting a first data format of the encrypted content and associated rights-of-use and decryption metadata to a second data format and a data distribution unit can be provided which distributes the encrypted content and the associated rights-of-use and decryption metadata in the telecommunication network. In this manner, the content can be inserted into the telecommunication network at a point which is secure for the content provider without there being a risk of manipulations of the content or a reduced protection of the rights of the respective content provider.

Furthermore, a purchase processing unit for handling purchase processing for an encrypted content can be provided between the terminal and a content provider or an entity instructed by a content provider as a result of which a highly flexible and provider-specific billing of contents can be implemented.

In this arrangement, the purchase processing unit can supply the at least one part of the encryption metadata to the rights management unit which thus provides a complete set of decryption metadata for the terminal.

As an alternative or in addition, the terminal can also have a metadata mixer which generates from the directly obtained at least one part of decryption metadata and an incomplete set of metadata a complete set of decryption metadata in the terminal.

Furthermore, the terminal can have a decentralized inventory management unit for managing the terminal, wherein the decentralized inventory management unit compares a functional-unit inventory list with rights-of-use metadata which are additionally provided by the clearing house, wherein the metadata mixer selectively actuates an unenabled functional unit of the terminal for a respective encrypted content when a functional unit not enabled for the content is determined during the comparison.

The functional unit can represent, e.g., a digital rights management-compliant reproduction device which decrypts the encrypted content with the decryption metadata. For outputting the decrypted content, an output unit can also be provided which is connected to the terminal via an encrypted interface.

The apparatus is preferably based on the AACS rights management standard and the rights-of-use metadata can contain a revocation list for identifying excluded functional units. Furthermore, the contents encrypted in accordance with the digital rights management and their associated metadata can be additionally encrypted for a transmission in the telecommunication network.

With regard to the method for securely distributing contents in a telecommunication network, encrypted contents and associated rights-of-use and decryption metadata are initially made available and distributed in a telecommunication network. After an evaluation of the rights-of-use metadata, a respective terminal of the telecommunication network is correspondingly actuated in dependence on the evaluated rights-of-use metadata and its contained functional units. In this manner, a deactivation, or an updating of terminals, can be implemented preferably for the selective reproduction of a content not adequately protected in accordance with the specifications of the rights protection of a content provider when functional units endangering the rights protection of the content provider, particularly the copy protection, are present.

Further advantageous embodiments of the invention are characterized in the further subclaims.

In the text which follows, the invention will be explained by way of example with reference to the AACS (Advanced Access Content Systems) standard as Digital Rights Management (DRM) in conjunction with an SPDC (Self Protecting Digital Content) architecture as DRM architecture for the protection of contents as used by AACS.

The Advanced Access Content System (AACS) is a digital rights management which, in particular, is used for recordable and prerecorded optical media and data media.

The AACS, which is also used for copy protection, has been specified by the companies Intel, Microsoft, Panasonic, Sony, Toshiba, Walt Disney and Warner Brothers.

The organization responsible for issuing the license for AACS is called “Advanced Access Content System License Administrator” (AACS LA). According to the AACS standard, all contents are encrypted with AES-128-bit encryption. In this process, there is a license key management, i.e., it is also possible, e.g., to generate protected copies with limited replay capability (in time or on particular drives). Furthermore, there is the possibility of blocking license keys. A drive verification is carried out by a hardware key. All components communicate with one another encrypted. Interworking with a telecommunication network and particularly with the Internet is possible. Combination with the Disk ID (Identification) is carried out with the license key. Furthermore, releasing and downloading/streaming of the contents by Internet is provided.

It is the aim of AACS to not make high-resolution video contents publicly accessible without encryption and without digital rights management. This goes beyond the previous copy protection, e.g. of a DVD (Digital Video Disk) and means a completely closed digital rights management. In this context, AACS relates to not only prerecorded media and on-line contents of, e.g., media servers but is also intended to extend to high-resolution recordings from, e.g. television transmissions (TV).

This results in high protection of the content by a comprehensive digital rights management which is supported by a multiplicity of renowned companies. In this connection, it provides for automatic decommissioning of corruptible devices which results in increasing motivation for the end users to use exclusively trustworthy sources for the desired contents. Furthermore, it is suitable for HD (High Density) contents and for the encrypted transmission of the contents via various interfaces.

The “Self Protection Digital Content” (SPDC) is a digital rights management architecture for protecting contents such as, e.g., video data or audio data which are used by the Advanced Access Content System (AACS).

SPDC enables the supplier of the content to change protection systems “dynamically” if an existing protection system is at risk of an attack. SPDC executes codes of protected content on the replay device and thus adds functionality in order to make the system “dynamic”. In comparison with the “static” systems in which the system and the keys for encryption and decryption are not changed, this results in an improvement. In the static system, any content which was released with this encryption system can be decrypted with a “cracked” key. “Dynamic” protection systems, in contrast, guarantee that content released in future becomes immune against an attack with an existing method of bypassing protection.

If weaknesses become apparent (either by reviewing or if it was possible to use the content without authorization) with respect to a reproduction method which is used for content already released, the method is changed by integration of code into the content for future releases. For the potential attacker, this means restarting the attacks.

If a particular model of replay devices is at risk of misuse, specific code components of the model can be activated in order to be able to verify in the case of a replay device of this model whether this device has already been misused. If a misuse has taken place, the replay device can be unambiguously identified (fingerprinted) and this information can be used later.

Code components which have been integrated into the (payload) content can add information for identifying the replay device. The information available at the output can be used for finding out the replay device. This information can also contain the unambiguous identity (fingerprint) of the replay device.

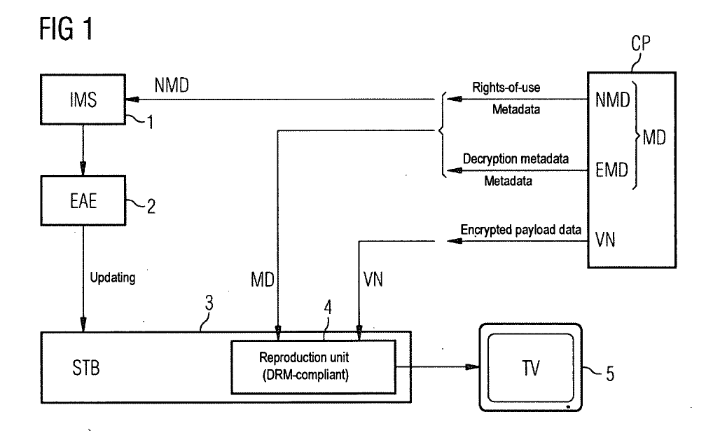

FIG. 1 shows a simplified block diagram for illustrating an apparatus for securely distributing contents in a telecommunication network according to the present invention which, for example, is based on the aforementioned AACS and SPDC standards.

According to FIG. 1, a content provider CP outputs a content in the form of an encrypted content or encrypted payload data VN, associated decryption metadata EMD and associated rights-of-use metadata NMD. The rights-of-use metadata NMD and the decryption metadata together result in the metadata MD belonging to the encrypted content VN. Whilst the encrypted payload data VN have the actual content such as, e.g. video data or audio data, the decryption metadata contain the key associated with the decryption and the rights-of-use metadata NMD, the rights of use issued in a digital rights management, such as, for example, a period of time of availability of the content, a permission for trick play modes, a time limit on the output after a purchase, a genre information, rating information, summary, binding information and permissibility information for push VoD (that is to say loading the content into a terminal, e.g. a set-top box, in advance of a later use by the subscriber which may take place) etc. According to the invention, these rights-of-use metadata can also contain, in particular, restrictions on use for a respective network operator/service provider which, for example, restricts the distribution of the content to a number of terminals (e.g. 100 000 terminals). Furthermore, such restrictions on use can take into consideration the geographic situations (e.g. permitted only in Germany), a number of the available video servers (e.g. five sites), a central replication (e.g. yesterday's TV allowed) etc. The aforementioned metadata can be present in encrypted form themselves, in which context other parts of the metadata may be necessary in each case for the decryption.

According to FIG. 1, the encrypted content or the encrypted payload data VN are now supplied to a terminal 3 and, particularly, its rights management-compliant reproduction unit 4. The terminal 3 can represent, for example, a telecommunication terminal interconnected into the telecommunication network such as, for example, a set-top-box STB.

The reproduction device 4 is, for example, a so-called “DRM-compliant player” which is compliant with the digital rights management implemented in the network such as, for example, the AACS standard. Furthermore, the reproduction unit 4 is supplied with at least the decryption metadata EMD for decrypting the encrypted content VN in the reproduction unit 4. Usually, however, it is not only the decryption metadata EMD but the entire metadata MD belonging to the encrypted content VN including the rights-of-use metadata NMD which are supplied. The reason for this is that generally the rights-of-use metadata can also have an influence on the derivation of the key information (s. Usage Rules of the AACS Standard). This means that the separation of the metadata into rights-of-use metadata and decryption metadata can be understood to mean that the rights-of-use metadata contain information which has relevance with regard to the rights protection. All other metadata which are not rights-of-use metadata in this sense are called decryption metadata. Knowing only the decryption metadata and the encrypted content does generally not enable the content to be decrypted.

According to FIG. 1, the rights-of-use metadata NMD, at least, are also supplied to an inventory management unit 1 for managing terminals 3 in the telecommunication network, the terminals 3 containing at least one functional unit such as, e.g., the reproduction unit 4. The inventory management unit 1 in each case has knowledge of all terminals 3 located in the telecommunication network and their respective functional units 4 and can accordingly manage these terminals 3 on the basis of the rights-of-use metadata NMD associated with the encrypted content VN.

Furthermore, according to FIG. 1, a terminal actuation unit 2 for actuating the terminals 3 is provided, wherein the inventory management unit compares the rights-of-use metadata NMD with a functional-unit inventory list and the terminal actuation unit 2 selectively actuates the terminal 3 for a respective encrypted content VN if the comparison determines a functional unit 4 which is not enabled for the content. Accordingly, to put it more precisely, a revocation list or exclusion list contained, for example, in the rights-of-use metadata NMD can be compared with a functional-unit inventory list which contains all functional units located in the network in accordance with their terminals, where a terminal can be blocked or deactivated for a particular content if it contains at least one functional unit 4 not enabled for this content. In this context, the selective actuation can include an actual deactivation or blocking of the terminal 3 or of a functional unit 4 but may also mean only a modification of a selection indication in, for example, a movie list or EPG (Electronic Program Guide) list of the terminal 3. The consequence of the latter can be, for example, that a critical content according to the above description is not offered to a subscriber for selection at the terminal 3.

If the terminal 3 has not been blocked for the encrypted content VN or there is a corresponding possibility of selecting the content, the encrypted content or the encrypted payload data VN are decrypted by use of the decryption metadata EMD in the reproduction unit 4, the decrypted content being provided at an output unit 5 such as, for example, a television set (TV).

For example, the output unit 5 can be connected to the terminal 3 via an encrypted interface such as, for example, HDCP (High-bandwidth Digital Content Protection). HDCP is an encryption system which is provided for the protected transmission of audio and video data. In this context, it can be used in conjunction with the HDTV (High Definition Television) standard or also in Blu-Ray or HD DVD (High Density Digital Video Disk).

In this manner, it is possible to ensure reliably for respective content providers CP also in a telecommunication network that their encrypted contents are not present in avoidably unencrypted form at any time or that there is a risk of unauthorized access. In this context, each terminal located in the telecommunication network can be selectively actuated in dependence on rights-of-use metadata.

Apart from the blocking of the terminal or the restricted possibility of selecting contents offered, described above, the selective actuation can also be an updating of the telecommunication terminal by the terminal actuation unit 2. Such updating includes, for example, a software update which creates from a non-compliant reproduction unit a reproduction unit which is now compliant for digital rights management as a result of which, e.g., terminals already in existence can still be used after an upgrade.

### VoD Scenario

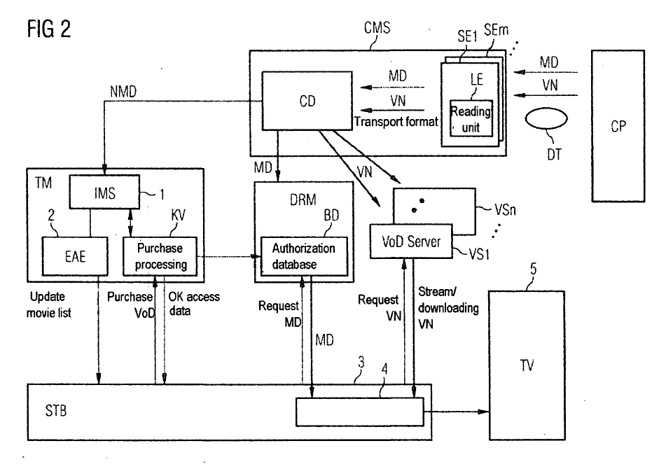

FIG. 2 shows a simplified block diagram for a VoD (Video on Demand) solution according to a first exemplary embodiment, wherein identical reference symbols designate identical elements as in FIG. 1 which is why the description will not be repeated in the text which follows.

According to FIG. 2, the inventory management unit 1 (IMS, Inventory Management System) and the terminal actuation unit 2 are located in a centralized coordination center such as, for example, a so-called “Total Management Middleware Server” TM. In this centralized coordination center TM, all telecommunication terminals 3 usually present in the network and, in particular, corresponding set-top boxes STB are centrally managed, in any case.

According to FIG. 2, the VoD solution according to the invention has a content management system CMS which has at least one interface adaptation unit (SE1-SEm) and a data distribution unit CD (Content Distribution). The interface adaptation unit SE1 to SEm implements an interface compliant according to the digital rights management, for example via a so-called staging area server (SAS). Via this interface, the content provider CP provides a content including the metadata MD defined with respect to the standard and the interface. In particular, the interface adaptation unit can have a drive for HD DVD (High Density Digital Video Disks) or Blu-Ray disks for adapting a first data format of the encrypted content VN and the associated rights-of-use and decryption metadata EMD and NMD to a second data format. Furthermore, an IP (Internet Protocol) interface can be provided via which the encrypted content VN can be downloaded from a content server of the content provider CP and the associated metadata can be delivered. In the latter case, the interface adaptation unit SE1-SEm and particularly its reading unit LE acts as client in a downloading scenario of the digital rights management standard.

In the simplest case, the content provider CP provides a disk according to the digital rights management standard or, respectively, a corresponding data medium DT such as, e.g. HD DVD or Blu-Ray on which the payload data VN encrypted in accordance with the digital rights management standard such as, e.g. a film or music, are also located. Although, in principle, an encryption by a digital rights management system additionally present in the VoD solution can be omitted, the encrypted contents VN and the associated metadata MD can be additionally encrypted for the transmission in the telecommunication network. This results in additional security for the entire system.

In the case of the AACS standard, the variants of a prerecorded and a recordable medium can occur which differ with respect to the metadata MD also supplied.

In the case of the recordable medium of the AACS standard, the metadata MD are, for example, Media Key Block (MKB), Media ID (Identification), Mac Value, Binding Nonce, encrypted key and Usage Rule which also determine the title key required for the decryption. At the same time, this allows a plausibility control of Media ID and Mac which decides the permissibility of the decryption.

In the case of the prerecorded medium of the AACS standard, the metadata MD are, on the one hand, Content Hash, Content Certificate, Content Revocation List (CRL) and, on the other hand, Media Key Block (MKB), Key Conversion Data (KCD), Sequence Key Block (SKB), Volume ID, encrypted keys and Usage Rules. Using the public keys specific to the AACS-compliant replay device, it is possible to determine that the data medium or medium DT is intact and that its content conforms to the digital rights management standard AACS. With the aid of the information specific to the AACS-compliant replay device, about device keys and sequence keys, the device can determine the title key required for the decryption from MKB, KCD and SKB, Volume ID and encrypted keys.

In the case where the content is physically provided on a data medium DT, a reading unit (inverse player) LE is provided in the interface adaptation unit or the staging area server (SAS), respectively, which reading unit, inversely to the functionality of the digital rights management-compliant reproduction device 4 does not output the decrypted content but the encrypted content and the metadata MD provided with it on the usually optical data medium DT for the purpose of decryption from the point of view of the rights of use.

This can be preceded by a check of the permissibility of the content (VN) by the functions of the inverse player or the reading unit LE, respectively. If during this check it is found that the content of the data medium DT is implausible in accordance with the digital rights management standard used such as, e.g. AACS, a corresponding output to the operator is produced and the content is rejected.

The second data format generated by the interface adaptation unit is, for example, a transport format (e.g. MPEG-2 TS) which can be used within the telecommunication network. To increase the protection, the containers of the transport stream can be optionally encrypted individually within this transport format. In this arrangement, for example, a specific container key with the key formed from the metadata MD for the encrypted content VN is encrypted and included in this form with the transport container. The corresponding editing of the transport stream is usually carried out in the staging area server (SAS) or the interface adaptation unit SE1 to SEm, respectively, which can also be distributed to a number of servers.

The interface adaptation unit or staging area server (SAS) also provides for the downloading of the content, encrypted in accordance with the digital rights management standard and present in transport format, to generally several content provisioning units which preferably represent VoD (Video on Demand) servers. According to FIG. 2, the distribution of the content and particularly the distribution of the encrypted payload data VN and of the metadata MD can also be carried out by a data distribution unit CD present in the content management unit CMS which results in an indirect distribution.

The metadata MD are preferably loaded in aggregate or as a complete set separately onto a server which preferably has a rights management unit DRM with an authorization database BD. According to FIG. 2, this can again be carried out indirectly via the data distribution unit CD of the content management unit CMS, wherein, in principle, a direct distribution by the interface adaptation unit or the staging area server (SAS), respectively, is also possible.

At least some of the metadata MD such as, e.g., the data which contain information necessary for updating the movie list displayed for the subscriber can be supplied indirectly by the data distribution unit CD to the centralized coordination center TM and the inventory management unit 1 located therein. In principle, this can also be implemented directly by downloading from the interface adaptation unit SE1 to SEm. Although preferably only the rights-of-use metadata NMD are loaded to the inventory management unit 1, all metadata MD can naturally also be provided to this unit but only the rights-of-use metadata NMD relevant to it will be processed further.

Since a rights-of-use metadata item NMD introduced according to the digital rights management standard such as e.g. AACS can lead to the impairment or disconnection of functions of the VoD solution, such rights-of-use metadata (NMD) and particularly the revocation list of the MKB of the AACS are notified to the inventory management unit 1 and are thus contained in the part of the metadata MD forwarded to the centralized coordination center TM. The inventory management unit 1 contained in the centralized coordination center TM comprises a functional-unit inventory list of all relevant terminals which correspond to the digital rights management standard. According to the invention, the rights-of-use metadata NMD are now checked for plausibility against the functional-unit inventory list of the inventory management unit 1 to form an encrypted content. If during this process it is found that a terminal 3 contains revoked functional units or devices for the first time, a message can be output to the operator for updating/retrofitting the terminal in order to subsequently provide for an updating or an upgrade/retrofit of the terminal by the terminal actuation unit 2.

According to FIG. 2, the encrypted content or film can be optionally not included in the movie list which, however, can be made possible again after an upgrade has been performed or an update has been carried out. This makes it possible to eliminate the potential impairment of the function of the subscriber device. As an alternative, the encrypted content can also be included in the movie list and when the film is called up, the compatibility of the metadata of the film with the functional units of the terminal 3 can be verified. If a subscriber with a terminal such as, for example, a Set-Top Box STB which contains a revoked device or an excluded functional unit then selects the video or the film which would potentially damage its function for outputting further videos or films, this can be avoided by outputting a suitable message to the user (“Set-Top-Box must be upgraded in order to output this film”). Furthermore, the terminal 3 can be deactivated or blocked by the terminal actuation unit 2 when an upgrade is not possible or desired and at the same time a functional unit is not enabled.

If accordingly the metadata MD received with the data medium DT contain a content revocation list, this can also be checked by the content management unit CMS against the content items deposited and a revoked content can be blocked by the content management unit via the inventory management unit 1 and the terminal actuation unit 2. By informing the coordination center TM, the revoked content can be deleted, for example, from the movie list and a corresponding message can be output to the operator.

Furthermore, a purchase processing unit KV can be provided in the centralized coordination center TM which handles purchase processing for an encrypted content (VN) between the subscriber of the terminal 3 and a content provider CP. If an encrypted content VN such as, for example, a video which has been inserted into the VoD solution via the interface adaptation unit is bought by a subscriber, the encrypted content (VN) is output in transport format to the terminal or the set-top box STB of the subscriber after the payment process has been handled in the purchase processing unit KV. The encrypted contents are then delivered by the VoD servers VS1 to VSn serving as content provisioning unit (stream/download).

The terminal 3 has a reproduction unit 4 which is compliant with the digital rights management, wherein the contained data, because of the preceding inventory check can be decrypted without risk with regard to loss of function and the decrypted data can be provided for the output unit 5 for output via the suitable interface. In this arrangement, the output unit 5 such as, for example, a television set is linked up in accordance with the requirements of the digital rights management such as, for example, a HDCP interface (High bandwidth Digital Content Protection).

In this arrangement, the functional unit or reproduction unit 4 of the terminal 3 preferably does not have an interface for replaying a digital rights management-compliant data medium but is still capable of processing the metadata MD provided for this data medium DT. Accordingly, the reproduction unit 4 preferably represents a replay device according to the digital rights management standard which does not have a real interface for a corresponding data medium DT or a corresponding physical medium, respectively.

All metadata MD relating to the content can be optionally inserted into the metadata of the digital rights management standard such as, e.g. in the form of usage rules which have, for example, a period of availability of the content, a permission for trick play modes, a time restriction on the output after a purchase, a genre information, rating information, summary, binding information, a push-VoD permissibility etc. In particular, these usage rules can also contain restrictions on the use for the network operator or service provider, wherein a content distribution can be restricted with regard to a number of terminals, a geographic situation, a number of video servers, a central replication etc.

In this manner, a VoD solution is obtained in which a complete decryption is carried out only a single time, namely in the terminal 3. In this context, the terminal 3 has as functional unit a reproduction unit 4 without a physical data medium interface which is compliant with the digital rights management standard. At the input end, there is a reading unit or an inverse replay device LE for separating metadata MD and encrypted content VN. To carry out a harmlessness check of the encrypted content, an inventory management unit 1 is provided preferably in the centralized coordination center TM, wherein a terminal actuation unit 2 actuates the terminal 3 in dependence on its rights-of-use metadata and a functional-unit inventory list, as a result of which upgrades, updating of movie lists, blocking of the terminal and/or of functional units is made possible.

Furthermore, it provides for a treatment of content revocations and/or a treatment of specific user rules as can already be present from existing network solutions. Thus, a respective network operator is only responsible for the operating infrastructure.

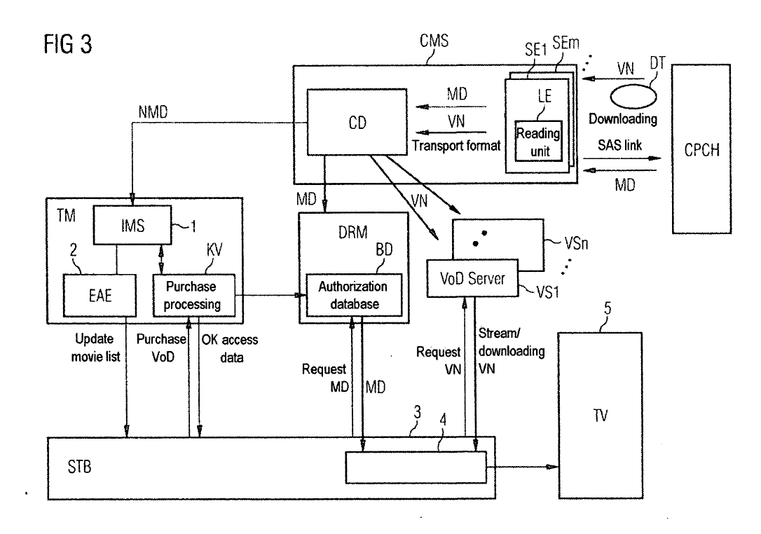

FIG. 3 shows a simplified block diagram for illustrating a VoD solution according to a second exemplary embodiment, wherein identical reference symbols designate identical elements as in FIGS. 1 and 2 which is why a repeated description is omitted in the text which follows.

According to FIG. 3, the data medium DT provided for the interface adaptation unit SE1-SEm cannot comprise the full metadata information. In this case, the interface adaptation unit or the staging area server (SAS) can turn to an entity of the content provider CP such as, for example, a clearing house CH in order to obtain the required metadata MD. This may be done by specifying a binding information wherein the interface adaptation unit SE1 to SEm acts as the only downloading client which only requests the metadata MD.

According to FIG. 3, the content provider CP and the clearing house CH are accordingly combined in one unit CPCH.

The content provider CP can also optionally load the encrypted content VN completely via a network link. In this case, too, all metadata MD are supplied to the interface adaptation unit SE1 to SEm and processed in the same manner as has already been described previously. In this case, however, the interface adaptation unit SE1 to SEm acts as the only downloading client which requests both the encrypted content VN and the metadata MD.

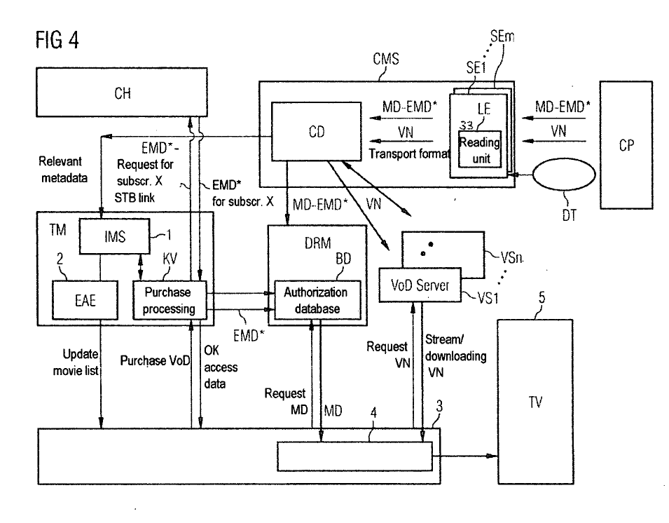

FIG. 4 shows a simplified block diagram for illustrating a VoD solution according to a third exemplary embodiment, wherein identical reference symbols designate identical elements as in FIGS. 1 to 3 which is why a repeated description is omitted in the text which follows.

According to FIG. 4, the content provider CP can optionally attach importance to wishing to control and possibly to bill, cover statistically and/or advertise to the individual subscribers separately. In this case, the interface adaptation unit SE1 to SEm loads the encrypted content VN and only the proportion of metadata MD-EMD* necessary for the central administration via a network link. The metadata relevant to the interface adaptation unit, particularly the binding information relevant to the interface adaptation unit, however, is not passed along to the terminal or the set-top box STB when a video or film is purchased so that the terminal or STB must turn directly to the content provider CP or their clearing house CH, by revealing their individual binding information, in order to obtain the missing information. In this context, the missing information can represent, in particular, a part of the decryption metadata EMD*. In this case, the content provider CP can directly obtain knowledge about the purchasers or the subscriber. The functional opening via the digital rights management thus provides for further business models. Due to the necessity of the inventory check according to the invention, such enquiries to the content provider are conducted, for example, by the purchase processing unit KV in the centralized coordination center TM. In this case, the decryption metadata EMD* which are still missing are supplied directly to the rights management unit DRM after conclusion of the purchase processing between the subscriber of the terminal 3 and the clearing house CH, where a complete set of decryption metadata EMD is provided for the terminal 3 or its reproduction unit 4, respectively.

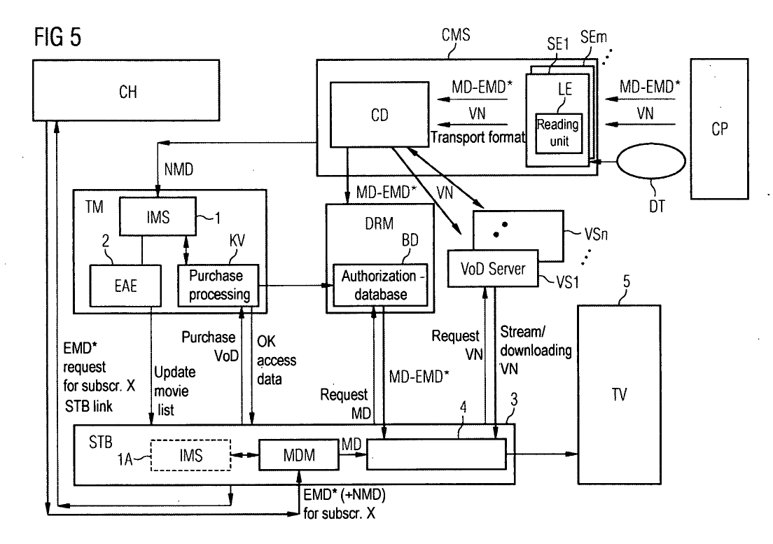

FIG. 5 shows a simplified block diagram for illustrating a VoD solution according to a fourth exemplary embodiment, wherein identical reference symbols designate identical elements as in FIGS. 1 to 4 which is why a repeated description will be omitted in the text which follows.

According to FIG. 5, the clearing house CH of the content provider CP can optionally also be contacted by bypassing the centralized coordination center TM or the purchase processing unit KV. In this case, the terminal can also have a decentralized inventory management unit 1A for managing the terminal 3, wherein the decentralized inventory management unit 1A compares a functional-unit inventory list preferably specific to the terminal 3 with rights-of-use metadata NMD and especially a revocation list, contained therein, which are additionally provided by the clearing house CH, wherein a further additionally arranged metadata mixer MDM actuates an unenabled functional unit of the terminal selectively for a respective encrypted content if a functional unit which is not enabled for the content is determined during the comparison. In this arrangement, the metadata mixer MDM provides from the at least one part of decryption metadata EMD* and the incomplete set of metadata MD-EMD* a complete set of decryption metadata EMD. As a result, unexpected incompatibilities with the data of the terminal 3 can lead to the end user and the network operator being informed. Accordingly, following a request of the part of the decryption metadata EMD*, further rights-of-use metadata NMD, apart from the part of decryption metadata EMD*, can also be provided for the terminal or a subscriber Tln.x which, in turn, are evaluated in the decentralized inventory management unit 1A and lead to a corresponding actuation of the terminal or the functional unit 4. In this case, an output of the video can be prevented or an upgrade is requested in the direction of a network operator or output as necessary prerequisite for the correct output of the video in the direction of the subscriber. Apart from maximum security, this provides high transparency for a content provider in a telecommunication network for securely distributing encrypted contents.

In the case of push VoD scenarios, that is to say the leading downloads of a (for example greatly requested content or video such as, e.g. a blockbuster) to the terminal or the set-top box STB, respectively, only the encrypted content VN is downloaded. Interaction with the clearing house CH and the payment system only occurs when the video is bought via the purchase processing unit KV. To this extent, the method described above is already adequate.

By shifting the control of the distribution of the content to the subscribers to, for example, a clearing house CH of the content provider CP, more extensive security measures can be implemented. The network operator thereby becomes transparent for the specifications of the digital rights management, wherein no free running separate adjustments are required on the infrastructure components of the network operator but an automatic realization of the specifications of the digital rights management can be implemented by possibly different content providers.

### TV Broadcasting Scenario

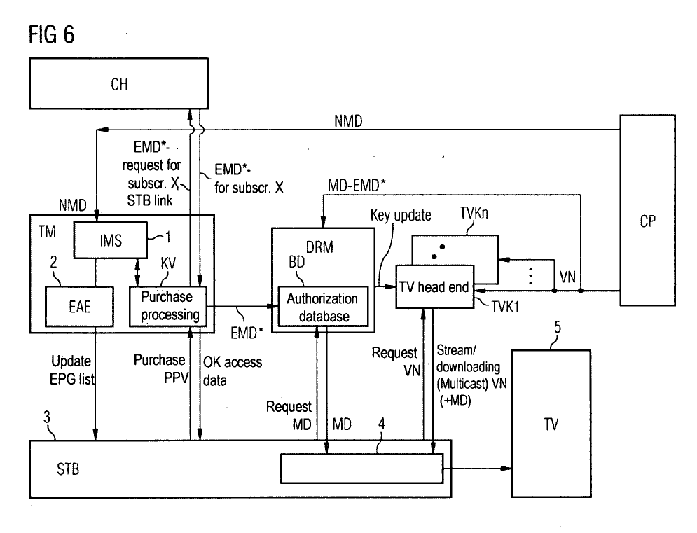

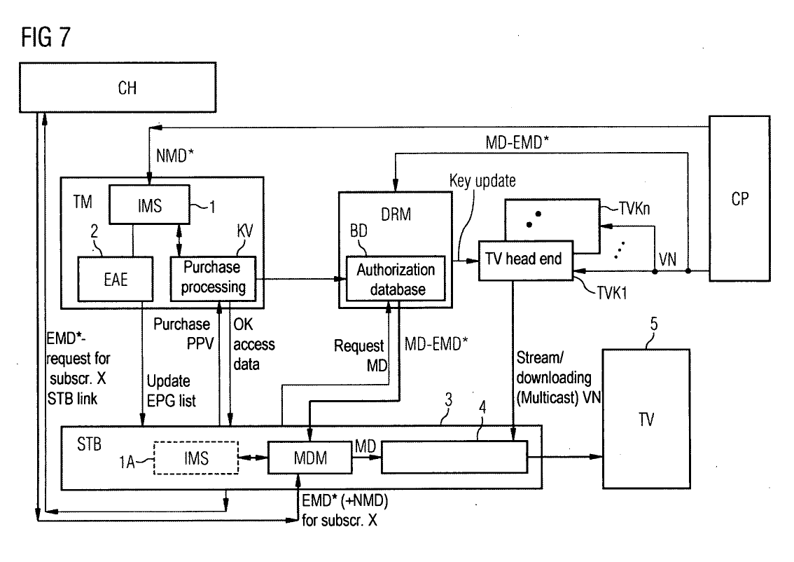

FIGS. 6 and 7 show simplified block diagrams of a TV broadcasting solution according to a first and second exemplary embodiment, wherein identical reference symbols designate identical elements as in FIGS. 1 to 5 which is why a repeated description will be omitted in the text which follows.

In this context, the purchase of a PPV (Pay Per View) transmission and of a channel-specific program of the broadcasting mode are very similar. The channel-specific program is a special case of a very long PPV event which is why the PPV (Pay Per View) case will be described explicitly in the text which follows.

FIG. 6 shows a simplified block diagram for illustrating such a TV broadcasting solution according to a first exemplary embodiment wherein, in contrast to the VoD solution described above, the content management unit CMS is omitted and instead of the VoD servers VS1 to VSn, so-called TV head ends TVK1 to TVKn are provided which can obtain a key update from the rights management unit DRM. The latter is possible if the metadata MD are to be transported completely in the transport stream or in the case of an additive encryption with the means of its own DRM system.

According to FIG. 6, the data necessary for the comprehensive digital rights management system must be transmitted to the terminal 3 as in the VoD solution. A part thereof can be transmitted in the transport stream, if necessary. Since the aim is binding the content to a medium but a medium necessary for the transport is not given, this is a case similar to the case of downloading a video. That is to say, the encrypted content VN, instead of the former, is bound to the TV head ends TVK1 to TVKn acting as content provisioning unit or directly to the terminal 3 or the set-top box (STB). In both cases, the TV head ends TVK1 to TVKn or the terminals 3, respectively, turn to the clearing house CH of the content provider CP, the conditions for the case of a binding to the terminal 3 being shown in the present case.

According to FIG. 6, the inventory check already known from FIGS. 1 to 5 occurs preferably centrally in the coordination center TM or its inventory management unit 1. In particular, a negative inventory check for a PPV event can lead to this PPV event not being output or marked in the EPG (Electronic Program Guide) data of a subscriber affected. This subscriber can thus not select this PPV event or is informed about a lack of suitability of his terminal 3.

According to FIG. 7, the inventory check can also occur decentralized in the terminal 3 or its decentralized inventory management unit 1A if there is decentralized binding via the terminal 3. A negative inventory check, in turn, leads to the operator being informed and the non-output of the PPV event with a recommendation for a required upgrade. Putting it more precisely, the critical PPV event is correspondingly marked, for example in the EPG (Electronic Program Guide) list output to the subscriber and/or a corresponding message appears when the PPV event is selected by the subscriber. The TV head end TVK1 to TVKn can leave the transport stream unchanged with regard to the encryption or again carry out additive encryption optionally in accordance with the specifications of an in-system digital rights management.

A PVR (Personal Video Recorder) functionality in the terminals 3 or the set-top box (STB) is taken into consideration via the registration at the clearing house CH. The fact that the PPV event can be copied in each case is apparent from the respective usage rules. These can pass into the terminal 3 explicitly via the clearing house CH directly, the content provider CP or by means of the transport stream.

A network-based PVR (Personal Video Recorder) functionality (nPVR) is part, for example, of a network-based recording functionality such as, e.g. “TV of yesterday”. A server responsible for this (not shown) must register for this purpose via the clearing house CH. Special rights of use can restrict a parallel usability for the end user. For example, no more than 1000 users may be allowed for a PPV event.

If it is only wished to control the creation of copies (no copy permissible, no temporary storage permissible, no permanent storage permissible), this restriction can also be transmitted alone in the form of a metadata item in the transport stream. In this case, interaction with the clearing house CH can be omitted. Storage of a PPV event on a local (integrated) PVR (Personal Video Recorder) can be separately subject to agreement and payment in accordance with the specification of the respective metadata. This information is then already contained in the metadata of the PPV event. If a subscriber only wishes to perform a temporary storage, this leads to the clearing house CH being contacted again. There is therefore potentially a first interaction from the terminal to the clearing house CH for outputting the PPV event or the encrypted content VN, respectively, and a second for the temporary storage of the PPV event or encrypted content VN, respectively.

FIG. 7 essentially corresponds to the TV broadcasting solution according to FIG. 6, exhibiting a direct actuation of the terminal 3 by a clearing house CH according to FIG. 5. To avoid repetitions, reference is therefore made to the description of FIG. 5.

### Generating Moving Data Media

Both in the VoD solution and in the TV broadcasting solution, the subscriber may wish to copy or to record a video or a TV program on a moving external data medium. This can be, in particular, an optical data medium such as, e.g., an HD DVD (High Density Digital Versatile Disk) or a Blu-Ray disk. For this case, the terminal can also have a recorder or a burner as functional unit which complies with the digital rights management standard. This compliant recorder or burner can be controlled e.g. via a remote control of the terminal 3 in dependence on the activity of the subscriber. In this context, it needs all metadata MD required in accordance with the digital rights management standard used, and a data medium compliant with the digital rights management. The prerequisite for creating a copy on the external data medium is that the metadata MD provided for the terminal 3 or the set-top box STB allow this copying process, in principle. This, in turn, is ensured via the inventory management unit 1 and associated terminal actuation unit 2.

If the metadata also mean that a copy is possible only after consulting an entity of the content provider CP such as, for example, a managed copy server of the AACS, the burning process is preceded by an interaction corresponding to the interaction with the clearing house CH of the content provider CP and conducted via the, for example, centralized coordination center TM or handled directly with the terminal 3. In this context, payment processes and registration processes may again become necessary via the purchase processing unit KV of the coordination center TM or the said entity of the content provider CP. Optionally, specific manipulations of the content such as, e.g. the application of watermarking, which are required for the selling process can also be triggered.

In this manner, PPV (Pay Per View) and TV broadcasting can also be implemented in addition to the video on demand implementation. Furthermore, client-based cPVR solutions and network-based nPVR solutions and “TV of Yesterday” or “Push VoD” are made possible via a clearing house of the content provider for implementing all relevant recording situations. Implementation of a terminal with a recording device compliant with the digital rights management standard also enables burning or writing on moving data media.

In the text which follows, an AACS-compliant VoD method is described in detail. Such a method allows a user to select a film available in the home entertainment system (HES) and—if all required prerequisites including those entailed by the AACS standard are met—to view the film in real time in the so-called streaming mode.

According to a basic sequence, the content provider supplies the film precoded and encrypted including the, e.g. AACS-compliant metadata MD. The content provider such as, e.g. the film studio, supplies the original film encoded (e.g. H.264) and encrypted to the network operator. The content provider subsequently delivers the metadata MD compliant according to AACS “recordable” or “prerecorded medium”, which are converted in accordance with the solution (XML, eXtended Markup Language) at management level so that they can be imported by the control level of the solution. In the present case, the management level is implemented, for example, by the content management unit CMS and the control level is implemented, for example, by the centralized coordination center TM.

In this context, the metadata are used for checking whether the functional unit or the reproduction unit 4 is AACS-compliant and the user is authorized to use the video (possibly extended user rules). The film or the encrypted payload data VN can be deposited on at least one VoD server via the content management unit (CMS). Before the video can be played, the reproduction unit 4 fetches the decryption metadata EMD necessary for generating the key for decrypting the film from the rights management unit DRM and/or additionally from the clearing house CH. After a successful check of the metadata MD and decryption on the AACS-licensed reproduction unit, the video can be played.

The following detailed sequence is obtained for an AACS-recordable medium, no additional encryption being subsequently provided in the system.

Firstly, the content provider CP provides for the staging area server SAS an AACS-standard-compliant data medium such as, e.g. HD DVD or Blu-Ray Disk with a film edited in accordance with the AACS standard. Apart from the coded and encrypted film, this data medium contains the metadata Media Key Block (MKB), Media IP, Mac Value, Binding Nonce, encrypted key and Usage Rule prescribed for recordable media in accordance with the AACS standard.

The validity of the content is checked by the staging area server by using the functions of the terminal or its replay device, respectively. If it is found during this process that the content of the data medium DT is implausible according to the AACS standard, a corresponding output is produced for the operator and the content is rejected.

The staging area server subsequently edits the content in the form of, for example, an MPEG(-2) (Moving Picture Experts Group) transport stream.

Using the output function described above, the staging area server (SAS) delivers the encrypted content or film and the associated AACS metadata MD separately to the data distribution unit CD.

The data distribution unit CD provides for a downloading of the content or film encrypted in accordance with AACS and present in MPEG-2 transport format to the VoD server or servers VS1 to VSn. The data distribution unit CD subsequently loads the metadata MD in aggregate or as a complete set or as a part-set MD-EMD* to the in-system rights management unit DRM.

A part of the metadata, e.g. the data which contain information necessary for updating the movie list displayed to the subscriber, and particularly the rights-of-use metadata NMD, are edited by the data distribution unit CD for the inventory management unit 1, for example in the XML (Extended Markup Language) format. These data can be imported by the middleware.

To prevent functions of the VoD solution from being impaired or disconnected by the introduction of the metadata introduced in accordance with the AACS standard, the revocation list of the MKB is also located in the AACS metadata packet or the rights-of-use metadata NMD for the centralized coordination center. The inventory management unit comprises an inventory list of the functional units of the various terminals, present in the network, a plausibility check being carried out with respect to this functional-unit inventory list for corresponding metadata of a respective encrypted content. If it is found during this check that a terminal contains revoked functional units for the first time, a message is output to the user (e.g. an operator of the network operator) for upgrading or updating the terminal.

The video can be included in the movie list and the compatibility of the metadata of the video with the functional units of the terminal can be verified when the video is called up. Optionally, the video can be included in the movie list only after a successful upgrading in order to eliminate any potential impairment of the function of the subscriber device.

If a subscriber with a terminal which contains a revoked functional unit or an excluded device then selects the video which would potentially damage a terminal function for outputting further videos, this is prevented by outputting a suitable message to the user (e.g. “terminal must be upgraded for outputting this film”).

If an encrypted content, which was introduced into the telecommunication system via the AACS-compliant interface, is purchased by a subscriber with a terminal checked according to AACS, which does not contain any revoked functional units, the encrypted content is output in transport format to the terminal of the subscriber after a payment process has been concluded.

At the same time, the terminal is provided with all associated metadata and particularly the needed decryption metadata EMD by the rights management unit DRM. Since the terminal 2 has an AACS-compliant reproduction unit 4, the received data can be decrypted without risk with regard to loss of function after the preceding inventory check.

The film is then decrypted on the AACS-compliant reproduction unit 4. For this purpose, first the protected area key (KPA) is calculated which is needed for decrypting the encrypted title key KT. By this means, the title key is subsequently decrypted. Apart from the KPA, the usage rules are also used for this computing process. Using the title key which is now decrypted, the MAC value is calculated/verified. This is compared with the MAC value of the AACS-compliant data medium provided, which was supplied with the metadata. If all checks were successful in accordance with the AACS standard, the encrypted film is decrypted with the aid of the title key.

Following this, the terminal can transmit the film to the output unit 5 or the TV set for output via the interface. In this arrangement, the TV set 5 can be linked in accordance with HDCP.

In the text which follows, a method for an AACS-prerecorded medium is described.

The content provider provides the staging area server (SAS) with a disk according to the AACS standard or a corresponding data medium DT with a film edited in accordance with the AACS standard. The data medium, in turn, can represent an HD DVD or a Blu-Ray disk. Apart from the encoded and encrypted film, this contains the metadata prescribed for prerecorded media in accordance with the AACS standard: Media Key Block (MKB), Key Conversion Data (KCD), Sequence Key Block (SKB), Volume ID, encrypted keys and usage rules.

The validity of the content is again checked by the staging area server by using the functions of the terminal or its replay device. If during this process it is found that the content of the data medium DT is implausible according to the AACS standard, a corresponding output is produced for the operator and the content is rejected.

The staging area server subsequently edits the content in the form of, for example, an MPEG(-2) (Moving Picture Experts Group) transport stream.

Using the output function described above, the staging area server (SAS) delivers the encrypted content or film and the associated AACS metadata MD separately to the data distribution unit CD.

The data distribution unit CD provides for downloading of the content or film, encrypted in accordance with AACS and present in the MPEG-2 transport format, to the VoD server or servers VS1 to VSn. The data distribution unit CD subsequently loads the metadata MD in aggregate or as a complete set or as a part set MD-EMD* to the in-system rights management unit DRM.

Some of the metadata, e.g. the data which contain information necessary for updating the movie list displayed to the subscriber are edited by the data distribution unit for the inventory management unit 1 in the centralized coordination center TM, performing, for example, a conversion into the XML format. In particular, rights-of-use metadata NMD and preferably an MKB with revocation list can be transmitted during this process.

These data can be imported by the middleware.

To prevent functions of the VoD solution from being impaired or disconnected by the introduction of the metadata introduced in accordance with the AACS standard, the revocation list of the MKB is also located in the AACS metadata packet or the rights-of-use metadata NMD for the centralized coordination center. The inventory management unit comprises an inventory list of the functional units of the various terminals, present in the network, a plausibility check being carried out with respect to this functional-unit inventory list for corresponding metadata of a respective encrypted content. If it is found during this check that a terminal contains functional units revoked for the first time, a message is output to the user for upgrading or updating the terminal.

The video can be included in the movie list and the compatibility of the metadata of the video with the functional units of the terminal can be verified when the video is called up. Optionally, the video can be included in the movie list only after a successful upgrade in order to exclude any potential impairment of the function of the subscriber device.

If a subscriber with a terminal which contains a revoked functional unit or an excluded device then selects the video which would potentially damage a terminal function for outputting further videos, this is prevented by outputting a suitable message to the user (e.g. “terminal must be upgraded for outputting this film”).

If an encrypted content which has been introduced into the telecommunication system via the AACS-compliant interface is purchased by a subscriber with a terminal checked according to AACS, which does not contain any revoked functional units, the encrypted content is output in the transport format to the terminal of the subscriber after a payment process has been concluded.

At the same time, all associated metadata and particularly the necessary decryption metadata EMD are provided to the terminal by the rights management unit DRM. Since the terminal 2 has an AACS-compliant reproduction unit 4, the received data can be decrypted after the preceding inventory check without risk with regard to loss of function.

The film is also decrypted on the AACS-compliant terminal or its reproduction unit 4, respectively. In this context, a key packet with public 253 device keys and 256 sequence keys, delivered by the AACS-LA, has already been integrated in the terminal 3 by the terminal manufacturer. Firstly, the device keys and the MKB supplied via metadata are used for calculating the media keys KM. Following this, the media key variant (KMV) is calculated with the aid of the KM and the sequence key block (SKB) also supplied via metadata. Using this KMV and the volume ID supplied via metadata, a hash is formed which is then used for decrypting the encrypted title key KT also supplied via metadata. The KT is then used for decrypting the encrypted film.

Thereafter, the terminal, in turn, can provide the film to the output unit 5 for output via the interface, the TV set being linked up, for example, via HDCP in accordance with the requirements of the AACS.

With regard to the TV broadcasting solution, current TV broadcast programs can be provided to the end user in real time via his, e.g., ADSL link (Asynchronous Digital Subscriber Line). This providing can be carried out, for example, via a “streamed” and/or “multicasted” system. Some of the programs must be paid separately. This pay TV is encrypted in order to prevent unauthorized use. One category of pay TV is the so-called “Pay Per View” (PPV) where it is necessary to pay for individual transmissions.

A further exemplary embodiment of the TV broadcasting solution with direct individual distribution control by the content provider is setting up an AACS-compliant copy, a so-called “managed copy” of prerecorded contents.

Possible scenarios are copies of the content in the reproduction unit 4 of the customer (e.g. cPVR) or copies within the range of content of a home entertainment solution (e.g. copy to several VoD servers in order to be able to rapidly access preferred contents).

In the text which follows, a PPV solution with decentralized inventory checking is described.

The scenario described in the text which follows is a case similar to the downloading of contents. For this purpose, the content provider distributes the PPV content, for example AES-encrypted with title key KT selected in accordance with the requirements of the AACS standard, directly to the terminal 3 or the set-top box STB, respectively. This content cannot yet be replayed on an AACS-compliant reproduction device. Furthermore, the content provider distributes relevant metadata (e.g. MKB, to the inventory management unit 1 in the centralized coordination center TM. The inventory check already known from the VoD solution is carried out here centrally in the coordination center TM because of the link via the terminal or the set-top box STB, respectively. An inventory check which is negative here leads to the operator being informed and the PPV event not being output, with a recommendation for a required upgrade.

However, in order to be able to replay the encrypted content via the AACS-compliant replay device or reproduction unit 4, a further inventory check is necessary additionally and for the sake of security. For this purpose, the terminal must communicate with the clearing house CH of the content provider. The clearing house receives the MKB and the so-called binding information “ticket” from the terminal, uses this to generate the necessary cryptographic information for decrypting the content and sends these back to the terminal.

After a successful inventory check with the central inventory management unit 1 and the clearing house CH, the terminal can offer the content or the PPV transmission or provided for output via the interface to the TV set 5. According to the requirements of AACS, the TV set, in turn, is linked via a HDCP interface, for example.

In the text which follows, a method for an AACS-compliant copy (managed copy) of prerecorded contents is described.

The Client Private Video Recording (cPVR) is mentioned as an exemplary embodiment of such an AACS-compliant “managed copy”. The client PVR provides for the recording and playing of contents broadcast via IPTV (Internet Protocol TV) on an AACS-compliant terminal. This terminal must contain an internal Hard Disk Drive (HDD) for the cPVR recording.

In this scenario, the terminal contains a licensed reproduction unit 4 and the functionality of a “managed copy machine” MCM. The clearing house here represents a “managed copy server” (MCS), not shown.

The PVR functionality in the terminal 3 is taken into consideration via the registration point of the clearing house CH. Whether the PPV event can be copied is apparent from the usage rules. These are distributed to the terminal by the clearing house CH or the content provider, respectively.

Apart from the encrypted payload data VN, the content provider also distributes the metadata MD relevant for the “managed copy” such as “scripts”, URL (Uniform Resource Locator), prerecorded Media Serial Number (PMSN), “Content ID”, etc.

The terminal, or its managed copy machine, respectively, uses the supplied URL in order to identify the clearing house with which it is intended to communicate for authorizing the creation of the copy.

The terminal generates and sends a request or “request offer” to the clearing house CH in order to determine which managed copy offers are available.

The clearing house CH generates a list of its offers and sends it to the terminal. The terminal provides this offer/selection list for the user. The terminal also sends a “request permission” request to the clearing house. The clearing house CH verifies this request and generates/sends a cryptographically protected response to the terminal 3. The terminal verifies the integrity of the response and when all conditions are met, the managed copy is started.

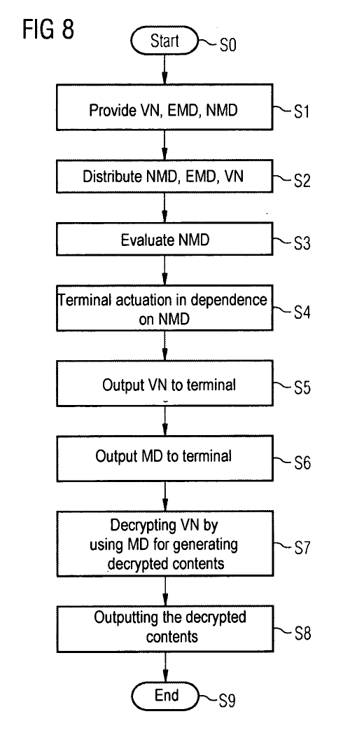

FIG. 8 shows a simplified flowchart for illustrating essential method steps of the method according to the invention for securely distributing contents in a telecommunication network.

After a start in step S0, an encrypted content VN and associated metadata MD are first provided to the system in the form of decryption metadata EMD and rights-of-use metadata NMD in a step S1. In a step S2, the metadata MD and the encrypted content VN are then distributed within the system or the network, respectively. In a step S3, in particular, the rights-of-use metadata NMD are evaluated by an inventory management unit, a terminal actuation taking place in dependence on the evaluated rights-of-use metadata NMD in a step S4.

In a step S5, the encrypted contents are output to the terminal and in a step S6 the decryption metadata needed for decrypting the encrypted content VN. In a step S7, the encrypted content VN is decrypted by using the metadata MD, as a result of which decrypted contents are generated which can be output in a step S8. The method ends in a step S9.

The invention has been described above by means of an AACS-compliant digital rights management system. However, it is not restricted to this and similarly also comprises alternative digital rights management systems. Furthermore, the invention has been described using a set-top box as terminal. However, it is not restricted to this and similarly also comprises alternative telecommunication terminals.

1.-35. (canceled)

36. An apparatus comprising:
an inventory management unit adapted to communicatively couple to a set-top box via a public packet-switched telecommunications network and adapted to manage a plurality of terminals responsive to rights-of-use metadata associated with encrypted content, each of said plurality of terminals comprising at least one functional unit, said metadata comprising a revocation list for excluding a subset of said functional units, said inventory management unit further adapted to compare said revocation list and a functional unit inventory list to determine that a functional unit of a terminal of said plurality of terminals is not enabled for said encrypted content; and
a terminal actuation unit adapted to communicatively couple to said telecommunications network and adapted to selectively actuate said terminal of said plurality of terminals for said encrypted content responsive to said comparison made by said inventory management unit between said revocation list and said functional unit inventory list.

37. The apparatus of claim 36, further comprising:
an interface to a clearinghouse, said clearinghouse adapted to provide a subset of decryption metadata associated with said encrypted content.

38. The apparatus of claim 36, further comprising:
a rights management unit adapted to provide said metadata associated with said encrypted content, said metadata comprising at least a residual part of decryption metadata.

39. The apparatus of claim 36, further comprising:
a content provisioning unit adapted to provide encrypted content to each of said plurality of terminals.

40. The apparatus of claim 36, further comprising:
a content provisioning unit adapted to provide encrypted content to said plurality of terminals, wherein said content provisioning unit is a Video on Demand (VoD) server.

41. The apparatus of claim 36, further comprising:
a content provisioning unit adapted to provide encrypted content to said plurality of terminals, wherein said content provisioning unit is a TV head end.

42. The apparatus of claim 36, further comprising:
a content management unit comprising at least one interface adaptation unit, said interface adaptation unit adapted to convert said encrypted content and said metadata from a first data format to a second data format.

43. The apparatus of claim 36, further comprising:
a data distribution unit adapted to distribute said encrypted content and said metadata via said telecommunications network.

44. The apparatus of claim 36, further comprising:
a data distribution unit adapted to distribute said encrypted content to a content provisioning unit and said metadata to said inventory management unit via said telecommunications network.

45. The apparatus of claim 36, further comprising:
a purchase processing unit adapted to process purchases of said encrypted content by each of said plurality of terminals from a content provider.

46. The apparatus of claim 36, further comprising:
a purchase processing unit adapted to process purchases of said encrypted content by each of said plurality of terminals from a content provider, wherein said purchase processing unit provides a subset of decryption data for said encrypted content.

47. The apparatus of claim 36, further comprising:
a purchase processing unit adapted to process purchases of said encrypted content by each of said plurality of terminals from a content provider, wherein said purchase processing unit provides a subset of decryption data for said encrypted content to a rights management unit.

48. The apparatus of claim 36, wherein:
each of said plurality of terminals further comprises a metadata mixer adapted to provide a complete set of decryption metadata.

49. The apparatus of claim 36, further comprising:
each of said plurality of terminals further comprises a metadata mixer adapted to provide a complete set of decryption metadata using a subset of decryption metadata associated with said encrypted content.

50. The apparatus of claim 36, wherein:
said terminal further comprises a decentralized inventory management unit adapted to compare said functional unit inventory with said rights of use metadata provided by a clearinghouse, and a metadata mixer adapted to selectively actuate an unenabled functional unit of said terminal for said encrypted content responsive to said comparison.

51. The apparatus of claim 36, wherein:
said functional unit is a rights-management-compliant reproduction unit which decrypts said encrypted content using decryption metadata.

52. The apparatus of claim 36, further comprising:
an output unit adapted to output said encrypted content and further adapted to connect to said terminal via an encrypted interface.

53. The apparatus of claim 36, wherein:
said apparatus conforms to AACS rights management standards.

54. The apparatus of claim 36, wherein:
said rights-of-use metadata and a subset of decryption metadata are provided by a plurality of rights management servers.

55. The apparatus of claim 36, wherein:
said encrypted content is provided by a plurality of content provisioning servers.

56. The apparatus of claim 36, wherein:
said encrypted content and said metadata are further encrypted prior to transmission over said telecommunications network.

57. The apparatus of claim 36, further comprising:
an interface adaptation unit comprising a removable data storage device, the removable data storage device containing said encrypted content and a subset of said metadata.

58. The apparatus of claim 36, wherein:
said functional unit is a rights-management-compliant recording unit adapted to write encrypted content and metadata to a data storage device.

59. A method comprising:
via a content management system adapted to communicatively couple to a set-top box via a packet switched telecommunications network
providing encrypted content and associated rights-of-use and decryption metadata via said telecommunications network, said rights-of-use metadata comprising a revocation list;
responsive to an evaluation of said revocation list, actuating a terminal responsive to a determination that a functional unit of said terminal is not enabled for said encrypted content.

60. The method of claim 59, further comprising:
outputting said encrypted contents and said decryption metadata to said terminal.

61. The method of claim 59, further comprising:
decrypting said encrypted contents using said decryption metadata and outputting said decrypted contents.

62. The method of claim 59, wherein:
a subset of said decryption metadata is output by a clearinghouse.

63. The method of claim 59, wherein:
a subset of said decryption metadata is output by a rights management unit.

64. The method of claim 59, wherein:
said encrypted contents are output by a content provisioning unit.

65. The method of claim 59, wherein:
said encrypted contents are output by a VoD server.

66. The method of claim 59, wherein:
said encrypted contents are output by a TV head end.

67. The method of claim 59, wherein:
the rights-of-use metadata are distributed to an inventory management unit;
the decryption metadata are distributed to a rights management unit; and
the encrypted contents are distributed to a content provisioning unit.

68. The method of claim 59, further comprising:
processing a purchase of said encrypted content by said terminal from a content provider.

69. The method of claim 59, further comprising:
assembling a complete set of decryption metadata from a subset of said decryption data output by a clearinghouse and a subset of said decryption data provided by a rights management unit.

70. The method of claim 59, further comprising:
decrypting said encrypted contents using a rights-management-compliant replay unit.

71. The method of claim 59, further comprising:
outputting a decrypted version of said encrypted content via an encrypted interface.

72. The method of claim 59, wherein:
said method conforms to AACS rights management standards.

73. The method of claim 59, further comprising:
additionally encrypting said encrypted contents and said metadata.
